(19) United States
(12) Patent Application Publication
(10) Pub. No.: US 2025/0371733 A1
(43) Pub. Date: Dec. 4, 2025

(54) END-TO-END ACTION DETECTION WITH OBJECT AWARE TRAINING

(71) Applicant: NEC Laboratories America, Inc., Princeton, NJ (US)

(72) Inventors: Deep Patel, Mount Holly, NJ (US); Erik Kruus, Hillsborough, NJ (US); Iain Melvin, Princeton, NJ (US)

(21) Appl. No.: 19/219,284

(22) Filed: May 27, 2025

Related U.S. Application Data
(60) Provisional application No. 63/652,317, filed on May 28, 2024.

(51) Int. Cl. G06T 7/70; G06T 7/20; G06V 10/82; G06V 20/70

(52) U.S. Cl. CPC G06T 7/70; G06T 7/20; G06V 10/82; G06V 20/70

(57) ABSTRACT

Systems and methods for action detection are provided. The systems and methods include extracting an object from a video frame and forming an embedding to provide an extracted object, labeling an action using natural language text, evaluating an attention between the extracted object and the action, matching the extracted object and the action with a minimum object-interaction loss, and tracking the extracted object through a set of continuous video frames.

### CROSS REFERENCE TO RELATED APPLICATIONS

This application claims priority to U.S. Provisional Patent Application No. 63/652,317, filed on May 28, 2024, incorporated herein by reference in its entirety.

### BACKGROUND

### Technical Field

The present invention relates to computer vision techniques and more particularly spatial-temporal action identification in videos.

### Description of the Related Art

Generating datasets for training artificial neural networks (ANNs) is a costly and time-consuming endeavor. Collecting enough data and enough variations in data to train ANNs are known difficulties in the field of ANN development. Furthermore, labeling the training data has additional issues such as the cost of human capital, cost of time, and accuracy concerns.

Other problems with supervised learning include potential for overfitting, rigid label learning, imbalanced datasets, lack of contextual understanding, poor adaptability, and difficulty scaling. Overfitting results from the model learning too much on the labels in the dataset instead of the concepts the labels represent. Rigid label learning is related to the model’s inability to learn new categories if those categories are not reflected in the labels already in the dataset. Imbalanced datasets reflect that some labels can be rare but important to the model and the model ignores those labels because of how infrequently they are encountered. For example, tracking fraud in banking statements, the fraud is infrequent but very important to detect. Lack of contextual understanding is similar to potential for overfitting and implies the model can miss a logical step in associating labels because of “shortcuts” the model has developed. Poor adaptability refers to frozen models being the norm and these models require retraining to learn new labels. Frozen models mean the model’s weights are static after training has been completed. Difficulty scaling occurs because each task requires a given labeled dataset, which is expensive and time consuming to produce.

### SUMMARY

According to an aspect of the present invention, a method is provided for action detection. The method includes extracting an object from a video frame and forming an embedding to provide an extracted object and labeling an action using natural language text. The method further includes evaluating an attention between the extracted object and the action, matching the extracted object and the action with a minimum object-interaction loss, and tracking the extracted object through a set of continuous video frames.

According to another aspect of the present invention, a system is provided for action detection. The system includes a processor, and a memory storing computer-readable instructions. The memory when executed by the processor, causes the system to extract an object from a video frame and forming an embedding to provide an extracted object and label an action using natural language text. The memory further causes the system to evaluate an attention between the extracted object and the action, match the extracted object and the action with a minimum cost assignment, and track the extracted object through a set of continuous video frames.

According to yet another embodiment of the present invention, a computer program product includes a non-transitory computer-readable storage medium containing computer program code. The computer program code when executed by one or more processors causes the one or more processors to perform operations, the computer program code comprising instructions to extract an object from a video frame and forming an embedding to provide an extracted object and label an action using natural language text. The computer program code further causes the processors to evaluate an attention between the extracted object and the action, match the extracted object and the action with a minimum cost assignment, and track the extracted object through a set of continuous video frames.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram illustrating a high-level system for an end-to-end action detection framework, in accordance with an embodiment of the present invention;

FIG. 2 is a block diagram illustrating components of the end-to-end action detection framework, in accordance with an embodiment of the present invention;

FIG. 3 is a block diagram illustrating components of the end-to-end action detection framework, in accordance with an embodiment of the present invention;

FIG. 4 is a flow diagram illustrating a method illustrating a method of performing the action detection framework, in accordance with an embodiment of the present invention;

FIG. 5 is a block diagram illustrating an exemplary processing system for the end-to-end action detection framework, in accordance with an embodiment of the present invention; and

FIG. 6 is a block diagram illustrating an artificial neural network (ANN), in accordance with an embodiment of the present invention.

### DETAILED DESCRIPTION OF PREFERRED EMBODIMENTS

A spatial-temporal action detection framework for videos with an end-to-end architecture and object-aware training can be useful. Embodiments of the present invention improve the modeling of object-action interactions without any explicit labels for the objects being interacted with. This can be performed by using a combination of a slot attention-based architecture, text encoder and (human-) object interaction loss. The framework can learn dynamic relationships between objects (and humans) through the object text information available in the action class labels.

For example, “playing” can imply the use of a ball as the object interacted with, or “arresting” can imply the use of handcuffs. In other embodiments of the present invention, using relevant object names based on the action category, such as “pulling” implies all objects that can be pulled (by including rope, a person, an article of clothing, etc.). Using non-explicit labels allows the framework to consider relationships between objects rather than identifying objects. This allows for a layer of abstraction for the model and for the model to better understand relationships rather than labels. This can also make the model capable of performing different tasks.

The relationships can be between two inanimate objects, two animate objects, or an animate and inanimate object. Examples herein can reference humans, users, or persons but other embodiments of the present invention contemplate other interactions such as two pieces of machinery interacting without human intervention or two animals interacting.

Embodiments of the present invention improve action detection in domains of public safety, healthcare, manufacturing, and retail. Humans actively interact with objects such as carrying a cup of coffee, touching a door, pushing a wheelchair, drinking from a bottle, etc. These interactions can involve a wide variety of objects, making the use of labels to understand these relationships more challenging and inefficient than focusing the interactions themselves. For example, an artificial intelligence (AI) model incorporated into or included in this framework can be prompted to identify “pick up,” and successfully identify a toy being lifted even if the actual toy being picked up has not been learned by the AI model since the action of picking up the toy is more relevant to the framework than the actual toy identification. Relying on labels of objects (i.e. employing methods not reflecting embodiments of the present invention) can necessitate learning an entire catalog of toys. Embodiments of the present invention make the AI model robust to changes in the interacted objects or catalog of potential objects to be interacted with, and learns a general representation for actions with object interactions without explicit object labels. The AI model can learn the action of picking up a toy and picking up a cup with equal accuracy and precision even if the label, "pick up," is available without the interacted with object.

Embodiments of the present invention can be used in resource management. For example, there are a plethora of different tools and types of hardware that are used in manufacturing and repair. Instead of accounting for inventory manually or having the AI model identify the objects directly, the objects can be tracked by the act of selecting the objects and using the objects. For example if a label is fastening, a saw or similar cutting device will not be considered while a wrench and nuts likely will be. Similarly, in the field of healthcare, elderly patients can be required to take medications they do not want to take. The model can track whether the medication (often in the form of oral pills) are ingested, instead of tracking the number and types of pills there are.

Another embodiment of the present invention can also be used in healthcare to improve patient care. Professionals in medicine can use different verbiage to articulate the same concept or the same verbiage to articulate different concepts which can lead to confusion without context, such as using the word “cervical” which can refer to female anatomy or the human spine. Applying artificial intelligence (AI) into medicine can account for these potentially confusing situations by providing context like considering other words like “crash” or “birth” which can assist in object detection that can be more relevant for one ambiguous word over another.

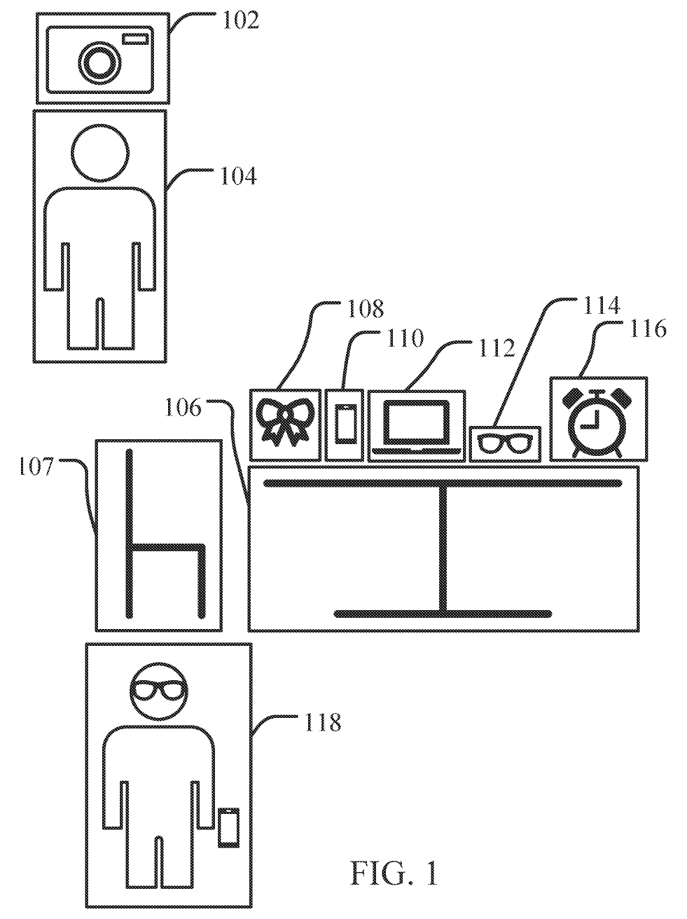

Referring now in detail to the figures in which like numerals represent the same or similar elements and initially to FIG. 1, a high-level block diagram for the end-to-end action detection framework is illustratively depicted in accordance with one embodiment of the present invention.

The framework can be demonstrated in a scene. A user 104 can interact with several objects in different ways which are distinct from one another. The actions can be captured by a video capture device 102, which can include cameras and video recorders. Other types of devices are also contemplated, some of which may capture images instead of videos. In other embodiments of the present invention audio, radio frequencies or other data can be collected instead of visual data or can be collected with visual data.

A table 106 can be one of the objects. Some text labels associated with the table 106 can be “sit” or “move.” The label “sit” can involve sitting on a chair 107 associated with the table 106. Even in circumstances when chair 107 is not mentioned, the action can be clear given the context.

A bow 108, a cell phone 110, a laptop 112, a set of glasses 114, and an alarm clock 116 can be objects user 104 interacts with when preparing to leave a room. Some possible interactions and associated labels may be (1) wear the bow 108; “put on,” (2) collect the cell phone 110; “hold,” (3) use the laptop 112; “send,” (4) wear the glasses 114; “put on,” and (5) turn off the alarm clock 116; “snooze.” Variations of the interaction and the labels are also possible. The variations can be in form or substance of the label or interaction.

After some time, user 104 can interact with the object such that they hold cell phone 110 and wear glasses 114. Since some of the objects can be interacted with in similar ways, action labels better differentiate the actions after context has reduced the number of possible interactions. For example, bow 108 can be worn instead of glasses 114. Bow 108, laptop 112, glasses 114, and alarm clock 116 can be held instead of cell phone 110. User 104 and various objects may appear different after interactions such as facial occlusion from glasses 114, making object identification more difficult without action labels. User 104 can then be designated as prepared user 118 after interacting with the objects. Prepared user 118 can leave the room now that the appropriate objects are taken. These actions can be identified by video capture device 102. Instances when prepared user 118 does not remember to take cell phone 110, the framework can remind prepared user 118 after having tracked the interactions of user 104 with the objects. The framework can ignore the alarm clock 116 and the laptop 112 when the action label is ”put on” since those are not objects that a human regularly wears or “puts on.” Reducing the number of possible objects that can be interacted with for a given label can improve the accuracy of the framework and reduce the computational load of the framework.

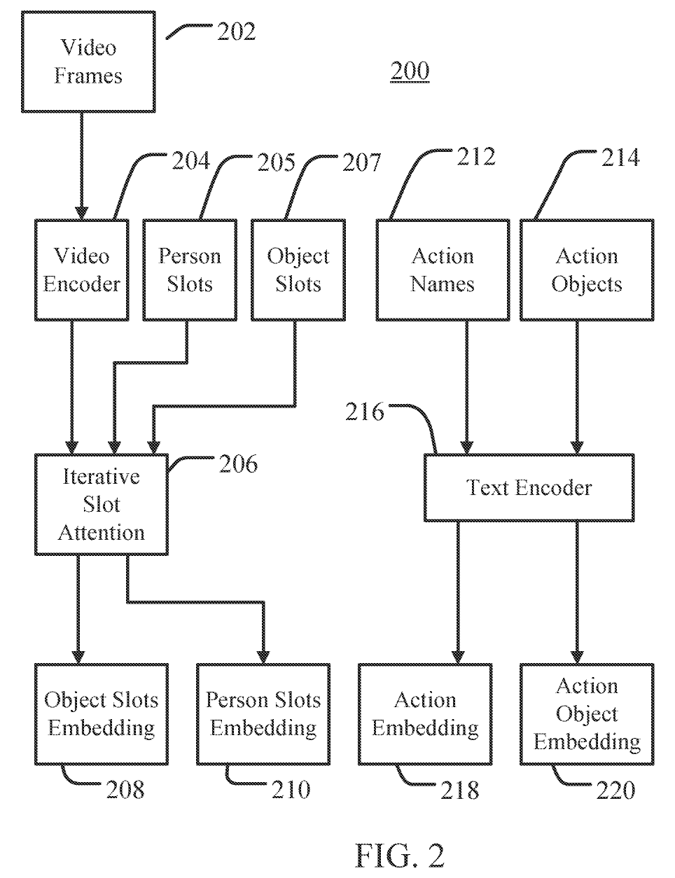

Now referring to FIG. 2, a block diagram illustrating end-to-end action detection framework 200 is depicted, according to an embodiment of the present invention. Embodiments of the present invention utilize a slot attention-based architecture to train for action detection. The architecture focuses on learning the relationship between objects without explicit labels or bounding boxes for the objects. The relationships are achieved using a slot attention mechanism that assigns weights to different object features from a text encoder 216 based on their relevance to each action.

The slot attention mechanism can be learned during training of end-to-end action detection framework 200. Even when datasets for training do not have explicit object interaction labels, text encoder 216 can be utilized to encode relevant object names (action objects) 214 and use the output text encoding of the objects. This causes the AI model (end-to-end action detection framework 200) to learn relevant relationships. For example, if the dataset contains labels for "pick up" action, a list of 50-100 objects/items that can be picked up (e.g., a book, a laptop, a phone, a bottle, etc.) can be created. This list of objects is passed to text encoder 216 which outputs corresponding text encoding for each of the object text (action object embedding 220). This encoding can be used during training to make the model implicitly learn and understand about the interacted objects.

Text encoder 216 processes textual information about objects, potentially from the action name 212 itself. This allows the model to understand the role of objects even without separate labels or bounding box localizations. Text encoder 216 can use natural language processing to understand the objects and the interactions.

Action name (action labels) 212 and action objects 214 are processed with a text encoder 216 to output respective embeddings for action embedding 218 and action object embedding 220. The embeddings can be in the form of features that are labels of actions. In an embodiment of the present invention, text encoder 216 can be a transformer model pretrained to process text after tokenizing with a text tokenizer (not depicted) based on the symbols and words present in the text.

Action object embedding 220 is obtained using pretrained text encoder 216 which employs encoders such as Bidirectional Encoder Representations from Transformers (BERT) or Contrastive Language-Image Pre-training (CLIP) models. These AI models take text as input and output a feature vector for the text. This output feature vector of the object text is matched with a corresponding object slot embedding 208 which is a similar sized feature vector. Text encoder 216 also produces action embedding 218.

Slot can be defined as a latent vector of embedding intended to represent a discrete object, concept, or entity. Attention can be defined as a mechanism that computes a weighed sum over a set of inputs based on their relevance to a query. Embed (Embedding) can be defined as a numerical representation of data in a continuous vector space. Object can be defined as a discrete and coherent entity in an image, identifiable by features. Feature can be defined as a measurable piece of data extracted from raw input. Action can be defined as a state of activity or state of inactivity that is identifiable.

The end-to-end action detection framework 200 can receive video frames 202 from video capture device 102 (FIG. 1) or other sources such as publicly accessible datasets. Video features are extracted by processing video frames 202 using a video encoder 204 that models the spatial and temporal dynamics in the input video frames 202. In an embodiment of the present invention, the video encoder 204 can be a transformer or three-dimensional convolutional neural network (3D CNN) model that can process and extract valuable features from video frames 202. Alternative embodiments of the present invention can use CNNs with a recurrent neural network (RNN), long-short term memory (LTSM), gated recurrent network (GRU), regular CNNs combined with other CNNs or 2D or 3D CNNs; transformers; graph neural networks (GNNs); self-supervised or contrastive models; Video Language Models (VLMs), etc. The extracted features are then processed by iterative slot attention 206 which iterates through each of the features in video frame 202, one at a time.

Iterative slot attention 206 is applied between the learnable slot parameters and video frames 202. The person slot 205 and object slot 207 extract useful information from video frames 202. The person slots 205 extracts information relevant to the person (e.g., motion information, pose, etc.), the object slots 207 extracts information relevant to the objects in the scenes (e.g., type, size) and the interaction with the person. Only one or two object slots are active for any person at a time and text embeddings of the object names (object slot embedding 208) are utilized to guide end-to-end action detection framework 200 to focus the relevant objects in the scenes interacted by the person slots.

The iterative slot attention 206 module also uses person slots 205 and object slots 207 to perform cross attention between the three inputs to output person slots embedding 210 and object slots embedding 208. The person slots embedding 210 represent visual and location information of the people present in video frames 202. The object slots embedding 208 represent visual and location information of the objects in video frames 202. In an embodiment of the present invention, the number of person slots 205 and object slots 207 can be determined based on the complexity of the scene in video frames 202 such as crowdedness, presence of different types of objects (such as in groups, carried by people, etc.). While this embodiment of the present invention includes person slot 205 and person slots embedding 210 modules for locating humans, other embodiments of the present invention may not have humans present and can be applied for any number of objects.

Iterative slot attention 206 learns a relationship between objects without explicit labels or bounding boxes by assigning weights to different object features from text encoder 216 based on their relevance to the action. The weights are obtained by performing self-attention between the person slots 205 and object slots 207. Once an attention map is formed, which is an all-to-all matrix between all person slots 205 and all object slots 207, the attention map can be used as cost matrix for a linear sum assignment algorithm to find a minimum cost assignment between the object slot 207 and the person slot 205. This outputs pairs of object slots 207 that match highly with the person slots 205. This matching is used to calculate a loss function which considers the ground truth action label of the person slot 205 (action name 212) and extracted text embedding of the object label (action object embedding 220) to guide end-to-end action detection framework 200 to explicitly make the object slot 207 focus on the object interacted by the person.

Action name 212 may be available but the label is limited. For example, text information about the object can be "pick up cellphone," but the explicit location of the cell phone in the scene is unknown. Therefore, the learning mechanism of slot attention is utilized to learn embeddings for objects (object slots 207) that can localize the interacted objects and provide end-to-end action detection framework 200 a better understanding of the interactions between human and object.

The relevance can be determined by natural language processing and transformers with a dot product and softmax, term-frequency-inverse document frequency, learning the weights in a neural network, manual or heuristic weights, etc. Iterative slot attention 206 can detect unknown actions by matching a highest attention between the object and the unknown action.

If the action objects 214 are not known or cannot be inferred from the available action name 212, the embeddings of the action objects 214 can be an aggregation of the embeddings from all the commonly associated objects with the action name 212.

For example, if the action name 212 is “put down,” objects that are commonly associated with put down actions such as, cup, bottle, newspaper, remote, bowl, spoon, laptop, etc. can be processed by the text encoder 216 and the output embeddings for the list of associated objects can be averaged to be used as “put down” object embedding.

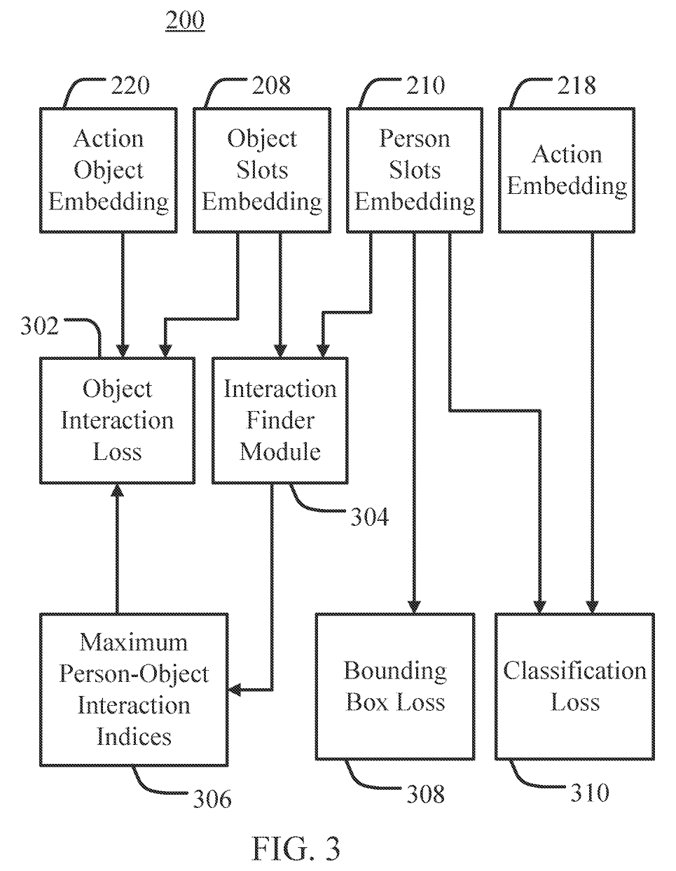

Now referring to FIG. 3, a block diagram illustrating end-to-end action detection framework 200 is depicted, according to embodiments of the present invention. Person slots embedding 210 and action embedding 218 are utilized to compute the bounding box loss 308 and classification loss 310. In an embodiment of the present invention, bounding box loss 308 can force the predicted bounding boxes from the person slot embedding 210 and the ground truth bounding box to have minimum L1 distance and high generalized box intersection over union. L1 distance is a metric used to measure the distance between two points in a space based on the sum of the absolute differences of their coordinates.

The bounding boxes can be predicted after applying a multi-layer perceptron and sigmoid activation. Classification loss 310 can minimize the negative log likelihood of the predicted actions and the ground truth action name 212 (FIG. 2). The action name 212 (FIG. 2) can be predicted by performing a dot product between the person slot embeddings 210 and the action embeddings 218. In alternative embodiments of the present invention, classification loss can be determined through cross-entropy loss (binary, categorial, sparse), focal loss, hinge loss, KL divergence, etc. Bounding box loss can also be determined through L2 loss, smooth L1 loss (e.g., Huber loss), IoU (intersection of union) loss, generalized/distance/complete IoU loss, etc.

Object aware loss (object interaction loss) 302 considers the person slot 205 and object slot 207 with highest attention between them. The object aware loss 302 then causes person slot 205 to match with action name 212 and object slot 207 to match with action objects 214. This allows end-to-end action detection framework 200 to learn evidential information about the person and object interaction without an explicit object location. If the action object 214 is not available, then embedding is generated by aggregating common objects that are associated with the action e.g., if the action is lifting, then commonly lifted objects are a cup, a spoon, a book, a laptop, etc., which can be used to get an aggregated embedding.

Action object embedding 220 and object slot embedding 208 are input to the interaction finder module 304 which finds the indices of maximum person object interactions 306. A linear sum assignment algorithm can be used to find matching between the person slots 205 and the object slots 207. The linear sum assignment algorithm outputs the indices of the person slots 205 and object slots 207 that produces the minimum cost of assignment. The minimum cost of assignment translates to indices which produces maximum person object interactions. For example, if there are three (3) person slots 205 and three (3) object slots 207, the linear sum assignment algorithm may output: (0, 1), (1, 2), (2, 0) which means the person slot 205 at index zero (0) matched with object slot 207 at index one (1), person slot 205 one (1) matched with object slot 207 two (2), etc.

In an embodiment of the present invention, interaction finder module 304 performs dot product attention between the action object embedding 220 and person slot embedding 210 and apply linear sum assignment algorithm (e.g., Hungarian Matching) to output the maximum matching indices for action object 214 (FIG. 2) with the person slot 205 (FIG. 2). Object interaction loss 302 guides the model to learn evidential information about the person and object interaction without explicit object location or object labels. The object interaction loss 302 computes the cosine similarity between the object slot 207 (FIG. 3) and the object slot embedding 208. The loss 302 function tries to maximize the cosine similarity between the two. This enforces that the two (2) embeddings vectors have similar direction and magnitude. For example, if the person action slot has a ground truth action of “playing basketball,” this loss will force the model to maximize matching between object slot embedding 208 (matched with corresponding person action slot of “playing basketball” by interaction finder module 304) with “basketball” action object embedding 220. In an embodiment of the present invention, this loss can be implemented as a contrastive loss to increase attraction between the matching action object embedding 220 and matched object slot 207 (FIG. 2) while maximizing distance between other action object embeddings 220.

The end-to-end architecture of the model is combined with the text encoder 216 (FIG. 2) and object interaction loss 302 which allows for many benefits. Among the benefits are that all the components of end-to-end action detection framework 200 can be trained together, integration of components can be faster, and there can be task-specific representations, end-to-end action detection framework 200 is backpropogation conducive. Other benefits can include that the end-to-end action detection framework 200 can be scalable and transferable, there can be better performance than a modular framework, and end-to-end action detection framework 200 is more maintainable. End to end learning can also scale with the amount of training data. In other words, with more data the results improve. Embodiments of the present invention enforce awareness in the AI model by using object interaction loss.

Video frames 202, video encoder 204, person slot 205, iterative slot attention 206, object slot 207, action name 212, action objects 214, text encoder 216, object interaction loss 302, interaction finder module 304, bounding box loss 308, and classification loss 310 are user inputs and deep learning modules. Object slot embedding 208, person slots embedding 210, action embedding 218, action object embedding 220, and interaction finder module 304 are internal representations and embeddings output by the modules.

The attention slot mechanism operates by using an interactive finder module 304 to weigh assignments. The interactive finder module 304 includes an attention layer which computes attention between object slot embeddings 208 and the person slot embeddings 210 to find the object slot 207 (FIG. 2) most attended by the person slot 205 (FIG. 2). The object slot embedding 208 and person slot embedding 210 are learnable parameters which can be set based on the complexity of the scene. For example, in a scene which contains one hundred (100) people and objects, the embedding size can be set to one hundred (100) for both persons and objects. The maximum attended object slot 207 for each person can be computed using linear sum assignment algorithm by performing methods, such as e.g., Hungarian matching, between all person slots 205 and object slots 207. Once the matching person slot 205 and object slot 207 creates pairs, the object slot embedding 208 associated with the action name 212 of the person is used to compute the loss function and guide end-to-end action detection framework 200 to focus on relevant objects interacted by the person. For example, if the person has an action label of "open refrigerator," end-to-end action detection framework 200 can utilize the text embedding of the "refrigerator" to match with the object slot embedding 208 paired with the person slot 205. If the action name 212 is ambiguous and does not explicitly contain the action name 212 (FIG. 2), a list can be collected of commonly associated object names and use the average of the text embeddings to match with the object slot. The matching is enforced using contrastive loss function which maximizes the cosine similarity between the object slot 207 and object name text embedding 220.

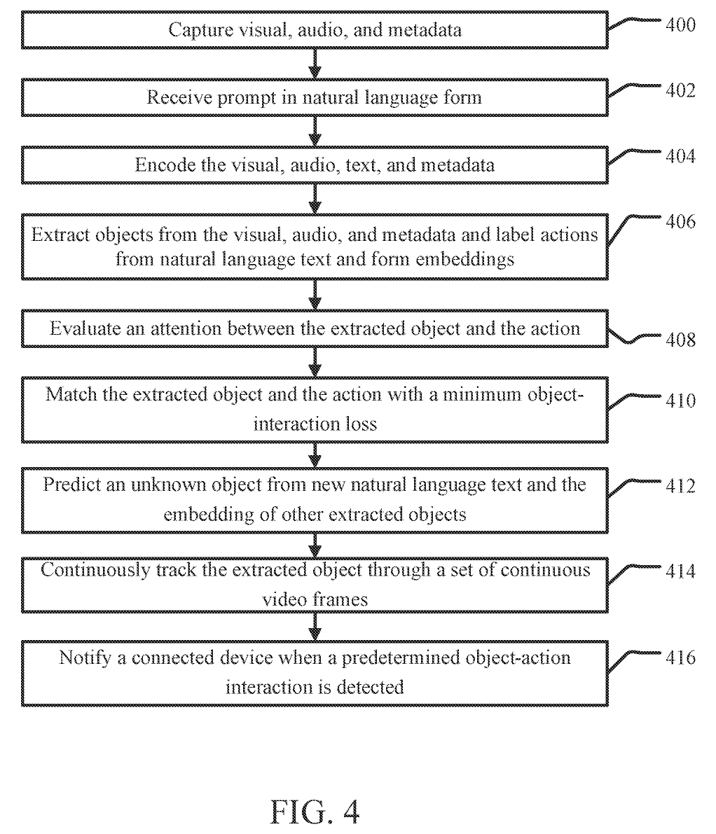

Now referring to FIG. 4, a flow diagram illustrating a method of performing the action detection framework is depicted, according to embodiments of the present invention.

In block 400, data is captured. The data in block 400 can be visual, audio, or metadata. The metadata can be related to the situation/scene or related to the visual and audio data. For example, metadata can include visual or audio data titles, creators, owners, etc. The data can be live, from a previously collected dataset, or from a public dataset. In block 402, a text prompt is received in natural language form. In block 404, the data is encoded. The encoding can come from transformers, natural language processing techniques, embeddings, spectrogram, raw waveform, feature aggregation, etc.

In block 406, features and labels are extracted from the data. The features and labels can come from visual, audio, metadata, and natural language. The method used to extract natural language can be bag-of-words, term frequency-inverse document frequency, word embeddings, sentence or document embeddings, linguistic or structural features, task-specific features, etc. Images can be extracted using convolutional neural networks (CNNs), image embeddings, etc. Audio data can be extracted using raw waveform, spectrogram/mel-spectrogram, mel-frequency cepstral coefficients, pretrained embeddings, etc.

In block 408, the attention between objects and actions is evalated. Evaluating the attention further includes determining localization and classification loss affiliated with a given bounding box or object, respectively. The highest attentions can be indexed. The attention is then assigned weights based on the object’s relevance. In block 410, the extracted object and the action can be matched using a minimum object-interaction loss. In block 412, unknown objects are predicted from new natural language text and the embedding of other extracted objects. Unknown objects can be determined using other objects associated with the action can be used to predict the object from the natural language text and aggregated embeddings of extracted objects. Unknown objects can include objects that the end-to-end action detection framework 200 is not familiar with because there has been insufficient training data on the object. In block 414, the extracted object is continuously tracked through a set of continuous video frames.

In block 416, a connected device can be notified when a predetermined object-action interaction is detected. The connected devices can include internet of things (IoT) devices connected to the internet. In other embodiments of the present invention the devices can also be connected to a local network. Notifying the connected device can trigger downstream actions when a pre-determined action is detected. The downstream actions can include engaging the connected device. The connected device can send a message, send a signal, turn a lever, actuate a piston, etc. For example, in the field of cooking, in response to the framework 200 detecting certain meal preparation activities can trigger the framework 200 (FIG. 2) to perform actions, such detecting that a pot of water is boiling can trigger framework 200 to lower the temperature and/or ping the user to add ingredients to the pot of water. Alternatively, in life-guarding of pools or beaches framework 200 (FIG. 2) can detect users flailing their arms while drowning. The motion of flailing arms can trigger notifying a life-guard of the location of the drowning person. In other embodiments of the present invention framework 200 (FIG. 2) can initiate autonomous vehicles to save the drowning person.

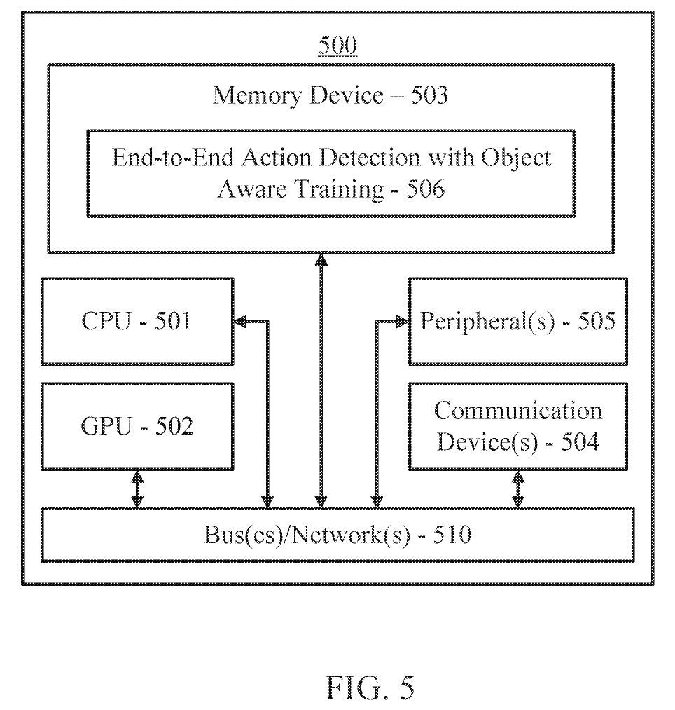

Referring to FIG. 5, a block diagram is shown for an exemplary processing system 500, in accordance with an embodiment of the present invention. The processing system 500 includes a set of processing units (e.g., CPUs) 501, a set of GPUs 502, a set of memory devices 503, a set of communication devices 504, and a set of peripherals 505. The CPUs 501 can be single or multi-core CPUs. The GPUs 502 can be single or multi-core GPUs. The one or more memory devices 503 can include caches, RAMs, ROMs, and other memories (flash, optical, magnetic, etc.). The communication devices 504 can include wireless and/or wired communication devices (e.g., network (e.g., Wi-Fi®, etc.) adapters, etc.). The peripherals 505 can include a display device, a user input device, a printer, an imaging device, and so forth. Elements of processing system 500 are connected by one or more buses or networks (collectively denoted by the figure reference numeral 510).

In an embodiment of the present invention, memory devices 503 can store specially programmed software modules to transform the computer processing system into a special purpose computer configured to implement various embodiments of the present invention. In an embodiment, special purpose hardware (e.g., Application Specific Integrated Circuits, Field Programmable Gate Arrays (FPGAs), and so forth) can be used to implement various embodiments of the present invention.

In an embodiment, memory devices 503 store program code or software 506 for end-to-end action detection with object aware training. The training implements one or more functions of the systems and methods described herein for extracting objects from video frames and forming embeddings to provide extracted objects, and labeling actions using natural language texts. The software 506 further includes evaluating an attention between the object and the action based on the extracted objects and the actions, detecting unknown action by matching a highest attention between the object and the unknown action, and tracking the objects through video frames. In further embodiments of the present invention the software 506 include determining a localization loss affiliated with the object and a classification loss affiliated with the action, predicting objects not learned by an artificial intelligence (AI) network from new natural language texts and the embeddings of the extracted objects, notifying a user in response to the object and the action interacting in an unexpected way, and communicating with a connected device in response to the predicted object performing trigger actions. In even further embodiments of the present invention the software 506 assigns weights to the objects based on the object’s relevance to the action and the processes metadata and audio from the data. The memory devices 503 can store program code for implementing one or more functions of the systems and methods described herein.

Of course, the processing system 500 may also include other elements (not shown), as readily contemplated by one of skill in the art, as well as omitting certain elements. For example, various other input devices and/or output devices can be included in processing system 500, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 500 are readily contemplated by one of ordinary skill in the art given the teachings of the present invention provided herein.

Moreover, it is to be appreciated that various figures as described with respect to various elements and steps relating to the present invention that may be implemented, in whole or in part, by one or more of the elements of system 500.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

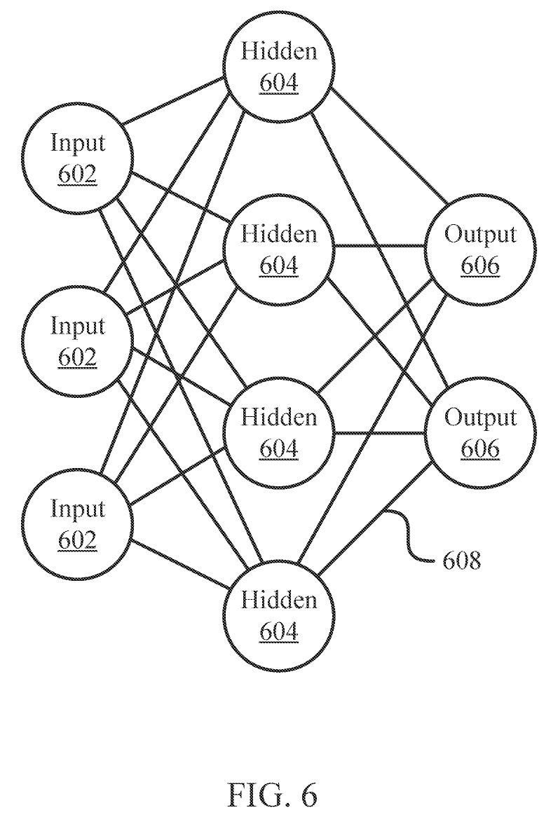

Referring now to FIG. 6, a generalized diagram of a neural network is shown. An artificial neural network (ANN) is an information processing system that is inspired by biological nervous systems, such as the brain. The key element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN is configured for a specific application, such as pattern recognition or data classification, through such a learning process. The ANN can identify patterns in text or other forms of communication and form embeddings for future processing. These patterns can relate actions and objects, relate objects to other objects, or actions to other actions. The ANN can identify seemingly unrelated or innocuous patterns or relationships with correlations. The ANN can bounding objects into bounding boxes, extract objects from bounding boxes, classify actions, embed objects from features, and extract actions from text, among other capabilities.

Although a specific structure of an ANN is shown, having three layers and a set number of fully connected neurons, it should be understood that this is intended solely for the purpose of illustration. In practice, the present embodiments may take any appropriate form, including any number of layers and any pattern or patterns of connections therebetween.

ANNs demonstrate an ability to derive meaning from complicated or imprecise data and can be used to extract patterns and detect trends that are too complex to be detected by humans or other computer-based systems. The structure of a neural network is known generally to have input neurons 602 that provide information to one or more “hidden” neurons 604. Connections 608 between the input neurons 602 and hidden neurons 604 are weighted, and these weighted inputs are then processed by the hidden neurons 604 according to some function in the hidden neurons 604. There can be any number of layers of hidden neurons 604, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. Finally, a set of output neurons 606 accepts and processes weighted input from the hidden neurons 604.

This represents a “feed-forward” computation, where information propagates from input neurons 602 to the output neurons 606. Upon completion of a feed-forward computation, the output is compared to a desired output available from training data. The error relative to the training data is then processed in “backpropagation” computation, where the hidden neurons 604 and input neurons 602 receive information regarding the error propagating backward from the output neurons 606. Once the backward error propagation has been completed, weight updates are performed, with the weighted connections 608 being updated to account for the received error. It should be noted that the three modes of operation, feed forward, back propagation, and weight update, do not overlap with one another. This represents just one variety of ANN computation, and that any appropriate form of computation may be used instead.

To train an ANN, training data can be divided into a training set and a testing set. The training data includes pairs of an input and a known output. During training, the inputs of the training set are fed into the ANN using feed-forward propagation. After each input, the output of the ANN is compared to the respective known output. Discrepancies between the output of the ANN and the known output that is associated with that particular input are used to generate an error value, which may be backpropagated through the ANN, after which the weight values of the ANN may be updated. This process continues until the pairs in the training set are exhausted.

After the training has been completed, the ANN may be tested against the testing set, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, each connection 608 weight may be characterized as a weight value that is stored in a computer memory, and the activation function of each neuron may be implemented by a computer processor. The weight value may store any appropriate data value, such as a real number, a binary value, or a value selected from a fixed number of possibilities, that is multiplied against the relevant neuron outputs. The ANN can be integrated into end-to-end action detection framework 200 (FIG. 2) by having the connections 608 representing the weights relating the slots of persons and objects. Input neurons 602 can be found in FIG. 2 in some embodiments of the present invention in the form of action name 212, video frames 202, action objects 214. Output neurons 606 can be found in FIG. 3 in object interaction loss 302, bounding box loss 308, and classification loss 310. Hidden neurons 604 can be found in FIGS. 2-3 in iterative slot attention 206, text encoder 216, object slot embedding 208, 210/, action embedding 218, embedding 220, interaction finder module 304, and maximum person object interactions 306. There can be several modules in the ANN that can perform the same, similar, or different tasks.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment,” as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for action detection training, comprising:
extracting an object from a video frame and forming an embedding to provide an extracted object;
labeling an action using natural language text;
evaluating an attention between the extracted object and the action;
matching the extracted object and the action with a minimum object-interaction loss; and
tracking the extracted object through a set of continuous video frames.

2. The method of claim 1, wherein evaluating the attention further comprises:determining a localization loss affiliated with the extracted object and a classification loss affiliated with the action.

3. The method of claim 1, wherein evaluating the attention includes assigning a weight to the extracted object based on a relevance of the action to the extracted object.

4. The method of claim 1, further comprising:
predicting an unknown object from new natural language text and the embedding of other extracted objects.

5. The method of claim 1, wherein extracting the object from the video frame and forming the embedding further includes providing the extracted object from metadata from the video frame.

6. The method of claim 1, wherein the extracting object from the video frame and forming the embedding further includes providing the extracted object from audio data from the video frame.

7. The method of claim 1, further comprising:
notifying a connected device when a predetermined object-action interaction is detected.

8. A system for action detection, comprising:
a processor; and
a memory storing computer-readable instructions that, when executed by the processor, cause the system to:
extract an object from a video frame and forming an embedding to provide an extracted object;
label an action using natural language text;
evaluate an attention between the extracted object and the action;
match the extracted object and the action with a minimum cost assignment; and
track the extracted object through a set of continuous video frames.

9. The system of claim 8, wherein the memory evaluates the attention by causing the system to:
determine a localization loss affiliated with the extracted object and a classification loss affiliated with the action.

10. The system of claim 8, wherein the memory evaluates the attention by causes the system to:
evaluate the attention by assigning a weight to the extracted object based on a relevance of the action to the extracted object.

11. The system of claim 8, wherein the memory further causes the system to:
predict an unknown object from new natural language text and the embedding of other extracted objects.

12. The system of claim 8, wherein extracting the object from the video frame and forming the embedding further includes providing the extracted object from metadata from the video frame.

13. The system of claim 8, wherein the extracting object from the video frame and forming the embedding further includes providing the extracted object from audio data from the video frame.

14. The system of claim 8, wherein the memory further causes the system to:
notify a connected device when a predetermined object-action interaction is detected.

15. A computer program product comprising a non-transitory computer-readable storage medium containing computer program code, the computer program code when executed by one or more processors causes the one or more processors to perform operations, the computer program code comprising instructions to:
extract an object from a video frame and forming an embedding to provide an extracted object;
label an action using natural language text;
evaluate an attention between the extracted object and the action;
match the extracted object and the action with a minimum cost assignment; and
track the extracted object through a set of continuous video frames.

16. The computer program product of claim 15, wherein the computer program code evaluates the attention by causing the processor to:
determine a localization loss affiliated with the extracted object and a classification loss affiliated with the action.

17. The computer program product of claim 15, wherein the computer program code evaluates the attention by causing the processor to:
evaluate the attention by assigning a weight to the extracted object based on a relevance of the action to the extracted object.

18. The computer program product of claim 15, further causes the processor to:
predict an unknown object from new natural language text and the embedding of other extracted objects.

19. The computer program product of claim 15, wherein extracting the object from the video frame and forming the embedding further includes providing the extracted object from metadata from the video frame.

20. The computer program product of claim 15, wherein extracting the object from the video frame and forming the embedding further includes providing the extracted object from metadata from the video frame.
